(19) United States
(12) Patent Application Publication
(10) Pub. No.: US 2021/0120468 A1
(43) Pub. Date: Apr. 22, 2021

(54) Enabling 5G NR Non-Standalone E-UTRAN Dual-Connectivity via Roaming

(71) Applicant: Google LLC, Mountain View, CA (US)

(72) Inventors: Erik Richard Stauffer, Sunnyvale, CA (US); Aamir Akram, San Jose, CA (US); Jibing Wang, San Jose, CA (US)

(73) Assignee: Google LLC, Mountain View, CA (US)

(21) Appl. No.: 17/254,486

(22) PCT Filed: Jun. 25, 2019
(86) PCT No.: PCT/US2019/038898

§ 371 Date: Dec. 21, 2020

Related U.S. Application Data
(60) Provisional application No. 62/690,794, filed on Jun. 27, 2018.

(51) Int. Cl. H04W 36/00; H04W 8/12

(52) U.S. Cl. CPC H04W 36/0069; H04W 8/12

(57) ABSTRACT

The present disclosure describes techniques and systems for enabling fifth generation new radio (5G NR) non-standalone (NSA) evolved universal terrestrial radio access network new radio dual-connectivity (EN-DC) via dual-connectivity roaming These techniques enable a user device (110) connected to a first service-provider network (602) to dual-connectivity roam onto a second service-provider network (604). The user device (110) can access the second service-provider network (604) (e.g., to support EN-DC in a non-overlapping area of the first service-provider network) while using an anchor link of the first service-provider network (602). In one example, a user device (110) on a Long Term Evolution (LTE) service-provider network (602) can dual-connectivity roam onto a 5G NR service-provider network (604) while using an anchor link of the LTE service-provider network (602) to access the second 5G NR service-provider network (604) and communicate using EN-DC.

### BACKGROUND

Fifth generation new radio (5G NR) non-standalone (NSA) evolved universal terrestrial radio access network new radio dual-connectivity (EN-DC) requires a Long Term Evolution (LTE) anchor link for control and support of a 5G NR non-anchor link. However, some service providers that have 5G NR coverage may not have sufficient LTE coverage in some geographic areas to support EN-DC throughout their coverage areas. If the service provider has 5G NR coverage in an area without LTE coverage, the EN-DC coverage cannot be enabled in that geographic area.

### SUMMARY

The present disclosure describes techniques and systems for enabling fifth generation new radio (5G NR) non-standalone (NSA) evolved universal terrestrial radio access network new radio dual-connectivity (EN-DC) via dual-connectivity (DC) roaming These techniques enable a user device connected to a first service-provider network to DC roam onto a second service-provider network. The user device can access the second service-provider network (e.g., to support EN-DC in a non-overlapping area of the first service-provider network) while using an anchor link from the first service-provider network. In one example, a user device on a first service provider's Long Term Evolution (LTE) or LTE-Advanced network can DC roam onto a 5G NR network of the second service provider while using an anchor link from the first service provider's LTE radio access network to access and enable dual-connectivity using the second service provider's 5G NR radio access network.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of enabling 5G NR NSA EN-DC via DC roaming are described below. The use of the same reference numbers in different instances in the description and the figures indicate similar elements:

FIG. 1 illustrates an example wireless network system in which various aspects of enabling 5G NR NSA EN-DC via DC roaming can be implemented.

FIG. 2 illustrates an example device diagram that can implement various aspects of enabling 5G NR NSA EN-DC via DC roaming.

FIG. 3 illustrates an example diagram of a 4G/5G NR NSA EN-DC network architecture.

FIG. 4 illustrates an example architecture of a 5G core network.

FIGS. 5A and 5B illustrate example implementations of a user equipment in range of various networks.

FIG. 6 illustrates an example implementation for enabling 5G NR NSA EN-DC via DC roaming.

FIG. 7 illustrates another example implementation for enabling 5G NR NSA EN-DC via DC roaming

FIG. 8 illustrates an alternative implementation for enabling 5G NR NSA EN-DC via DC roaming.

FIG. 9 illustrates another alternative implementation for enabling 5G NR NSA EN-DC via DC roaming.

FIG. 10 depicts an example method of enabling 5G NR NSA EN-DC via DC roaming in a user device in accordance with aspects of the techniques described herein.

FIG. 11 depicts an example method of enabling 5G NR NSA EN-DC via DC roaming in a network in accordance with aspects of the techniques described herein.

### DETAILED DESCRIPTION

Fifth generation new radio (5G NR) non-standalone (NSA) evolved universal terrestrial radio access network new radio dual-connectivity (EN-DC) requires an LTE anchor link for control and support of a 5G NR non-anchor link (e.g., wireless communication link). However, some service providers that have both LTE and 5G NR coverage may not have sufficient 5G NR coverage in some geographic areas to support and enable EN-DC coverage throughout their LTE coverage area.

This document describes techniques and systems for enabling 5G NR NSA EN-DC via DC roaming. These techniques enable a user device (e.g., a user equipment or UE) connected to a first service-provider network to DC roam onto a second service-provider network. The user device can access the second service-provider network while using an anchor link from the first service-provider network. In one example, a user device on a first service provider's Long Term Evolution (LTE) network can use an anchor link of the first service provider's LTE radio access network while accessing another service provider's 5G NR radio access network to communicate using EN-DC. Alternatively, a user device, subscribed to services of the second service provider and located in a coverage area of the second service provider's 5G NR network, which does not overlap with the second service provider's supporting LTE network, can DC roam onto the first service provider's LTE network and use an anchor link of the first service provider's LTE radio access network (RAN) while accessing the second service provider's 5G NR RAN to communicate using EN-DC.

### Operating Environment

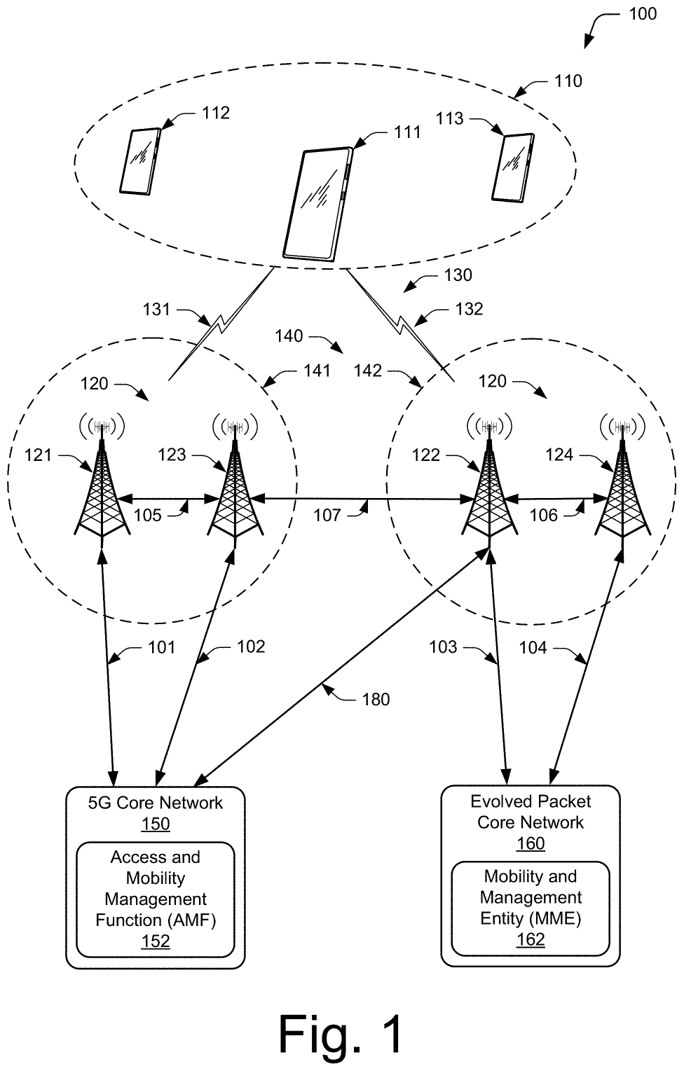

FIG. 1 illustrates an example environment 100, which includes multiple user equipment 110 (UE 110), illustrated as UE 111, UE 112, and UE 113. Each UE 110 can communicate with base stations 120 (illustrated as base stations 121, 122, 123, and 124) through wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof. One or more of the base stations 120 can operate as a serving cell, a primary cell or a secondary cell.

The base stations 120 communicate with the UE 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110. When a UE 110 is connected to an E-UTRAN 142 using an anchor link and also to an NR RAN 141 for dual connectivity, the result is EN-DC.

The base stations 120 are collectively a Radio Access Network 140 (e.g., RAN, Evolved Universal Terrestrial Radio Access Network, E-UTRAN, 5G NR RAN or NR RAN). The RANs 140 are illustrated as an NR RAN 141 and an E-UTRAN 142. The base stations 121 and 123 in the NR RAN 141 are connected to a Fifth Generation Core 150 (5GC 150) network. The base stations 122 and 124 in the E-UTRAN 142 are connected to an Evolved Packet Core 160 (EPC 160). Optionally or additionally, the base station 122 may connect to both the 5GC 150 and EPC 160 networks.

The base stations 121 and 123 connect, at 101 and 102 respectively, to the 5GC 150 through an NG2 interface for control-plane signaling and using an NG3 interface for user-plane data communications. The base stations 122 and 124 connect, at 103 and 104 respectively, to the EPC 160 using an S1 interface for control-plane signaling and user-plane data communications. Optionally or additionally, if the base station 122 connects to the 5GC 150 and EPC 160 networks, the base station 122 connects to the 5GC 150 using an NG2 interface for control-plane signaling and through an NG3 interface for user-plane data communications, at 180.

In addition to connections to core networks, the base stations 120 may communicate with each other. For example, the base stations 121 and 123 communicate through an Xn interface at 105 and the base stations 122 and 124 communicate through an X2 interface at 106. At least one base station 120 (base station 121 and/or base station 123) in the NR RAN 141 can communicate with at least one base station 120 (base station 122 and/or base station 124) in the E-UTRAN 142 using an Xn interface 107. In aspects, base stations 120 in different RANs (e.g., master base stations 120 of each RAN) communicate with one another using an Xn interface such as Xn interface 107.

The 5GC 150 includes an Access and Mobility Management Function 152 (AMF 152), which provides control-plane functions, such as registration and authentication of multiple UE 110, authorization, and mobility management in the 5G NR network. The EPC 160 includes a Mobility Management Entity 162 (MME 162), which provides control-plane functions, such as registration and authentication of multiple UE 110, authorization, or mobility management in the E-UTRA network. The AMF 152 and the MME 162 communicate with the base stations 120 in the RANs 140 and also communicate with multiple UE 110, using the base stations 120. In aspects of enabling 5G NR NSA EN-DC via DC roaming described herein, a service-provider network includes at least one RAN and at least one core network.

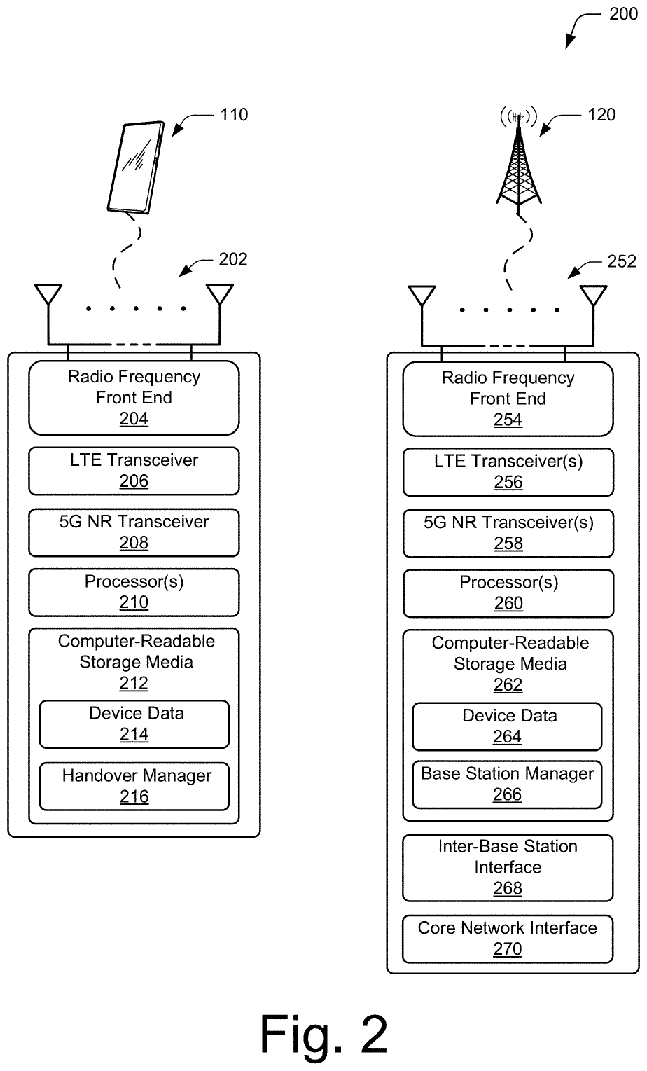

FIG. 2 illustrates an example device diagram 200 of the user equipment 110 and the base stations 120. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, and a 5G NR transceiver 208 for communicating with base stations 120 in the RAN 140. The RF front end 204 of the user equipment 110 can couple or connect the LTE transceiver 206 and the 5G NR transceiver 208 to the antennas 202 to facilitate various types of wireless communication. The antennas 202 of the user equipment 110 may include an array of multiple antennas that are configured similarly to or differently from each other. The antennas 202 and the RF front end 204 can be tuned to, and/or be tunable to, one or more frequency bands defined by the 3GPP LTE and 5G NR communication standards and implemented by the LTE transceiver 206 and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The user equipment 110 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the user equipment 110. The device data 214 includes user data, multimedia data, beamforming codebooks, applications, and/or an operating system of the user equipment 110, which are executable by processor(s) 210 to enable user-plane communication, control-plane signaling, and user interaction with the user equipment 110.

In some implementations, the CRM 212 may also include a handover manager 216. The handover manager 216 can communicate with the antennas 202, the RF front end 204, the LTE transceiver 206, and/or the 5G NR transceiver 208 to monitor the quality of the wireless communication links 130. Based on this monitoring, the handover manager 216 can determine to trigger a handover.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and/or the 5G NR transceivers 258 to the antennas 252 to facilitate various types of wireless communication. The antennas 252 of the base stations 120 may include an array of multiple antennas that are configured similarly to or differently from each other. The antennas 252 and the RF front end 254 can be tuned to, and/or be tunable to, one or more frequency band defined by the 3GPP LTE and 5G NR communication standards and implemented by the LTE transceivers 256 and one or more 5G NR transceivers 258. Additionally, the antennas 252, the RF front end 254, the LTE transceivers 256, and/or one or more 5G NR transceivers 258 may be configured to support beamforming, such as Massive-MIMO, for the transmission and reception of communications with the UE 110.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the user equipment 110.

CRM 262 also includes a base station manager 266. Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the user equipment 110, as well as communication with a core network, such as the core network 150, and routing user-plane and control-plane data for joint communication. Additionally, the base station manager 266 may allocate air interface resources and schedule communications for the UE 110 and base stations 120 when the base station 120 is acting as a master base station for the base stations 120. The base station manager 266 may configure the LTE transceivers 256 and the 5G NR transceivers 258 to support EN-DC communication with the user equipment 110.

The base stations 120 include an inter-base station interface 268, such as an Xn and/or X2 interface, which the base station manager 266 configures to exchange user-plane and control-plane data between other base stations 120, to manage the communication of the base stations 120 with the user equipment 110. The base stations 120 include a core network interface 270 that the base station manager 266 configures to exchange user-plane and control-plane data with core network functions and/or entities. The base station manager 266 may use the inter-base station interface 268, along with the LTE transceivers 256 and/or the 5G NR transceivers 258, to support EN-DC communications to, or from, the user equipment 110 by base stations 120 of different service providers (e.g., base station 122 of E-UTRAN 142 and base station 123 of NR RAN 141).

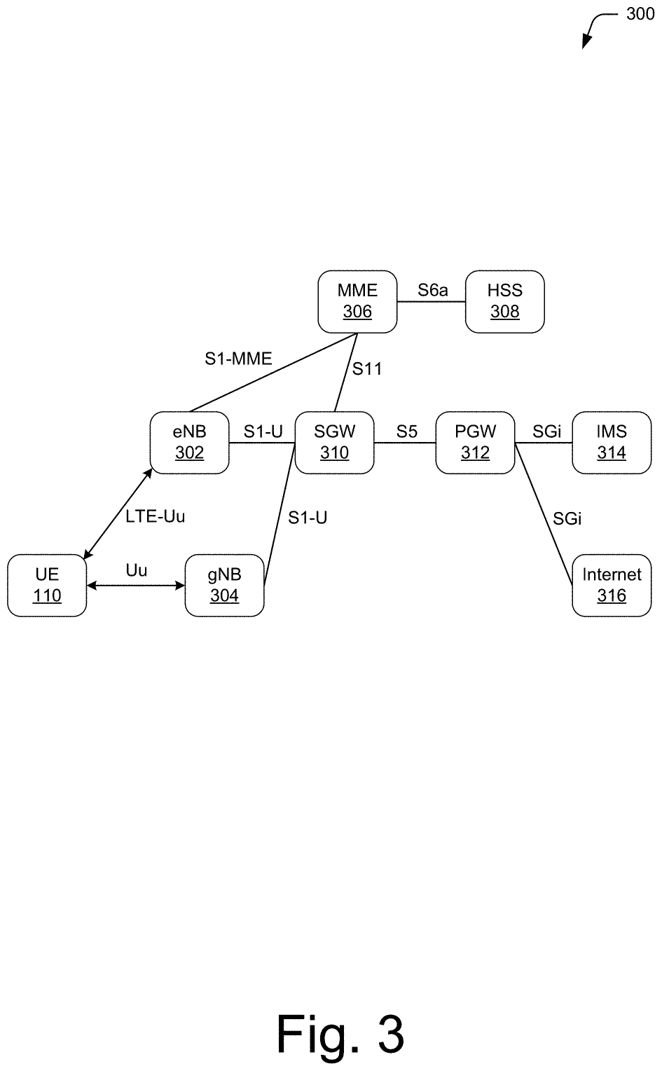

FIG. 3 illustrates an example diagram 300 of a 4G/5G NR NSA EN-DC network architecture for a service-provider network. The elements in the example network architecture communicate with one another via a variety of non-roaming interfaces. The example network includes a user equipment 110 communicating with an eNB 302 (e.g., using the well-known LTE-Uu interface) to support an anchor link and communicating with a gNB 304 (e.g., using the well-known Uu interface) to support one or more non-anchor links to provide EN-DC to the UE 110. The eNB communicates with a Mobility Management Entity (MME) 306 via an interface, (e.g., a well-known S1-MME interface). The MME 306 communicates with a Home Subscriber Server (HSS) 308 via an interface, such as a well-known S6a interface. The eNB 302 and the gNB 304 can also communicate with a Serving Gateway (SGW) 310, such as by using a well-known S1-U interface. The SGW 310 can interface with the MME 306 (e.g., via a well-known S11 interface) as well as a Packet Gateway (PGW) 312 (e.g., via a well-known S5 interface). The PGW 312 is configured to interface with an Internet Protocol Multimedia Subsystem (IMS) 314 (e.g., via a well-known SGi nterface) and the Internet 316.

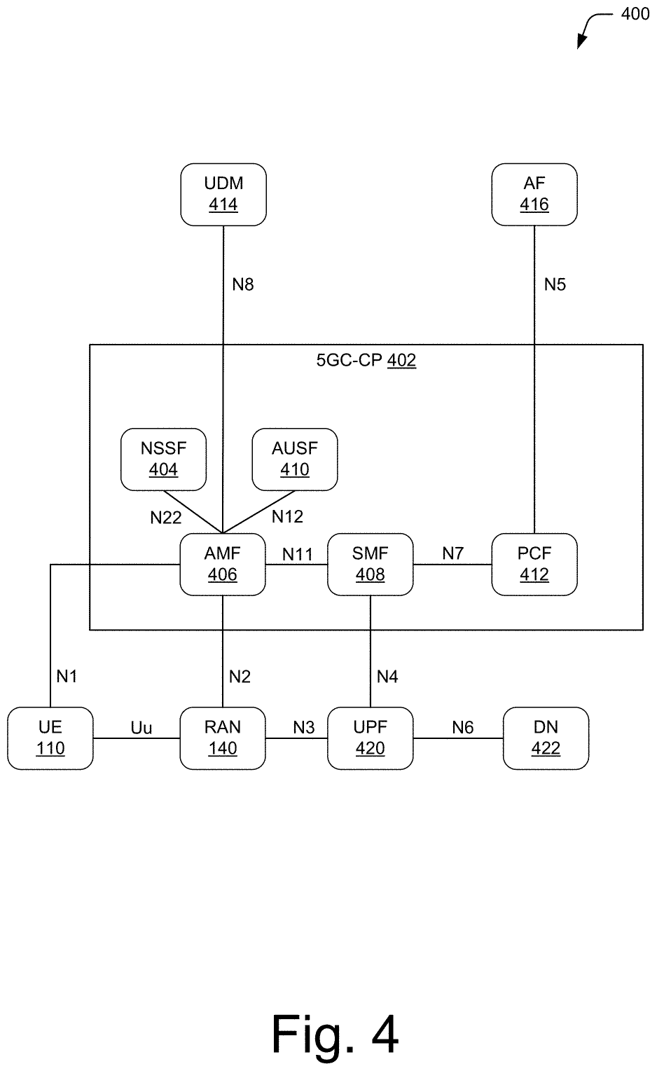

FIG. 4 illustrates an example arc hitecture 400 of a 5G core network. In the illustrated example 400, control and user planes are separated. Here, network functions within the 5G Core Control Plane (5GC-CP) 402 use Service-Based Interfaces for their interactions. In aspects, a control plane network function can provide one or more network function services.

Example network functions with the 5GC-CP 402 include a Network Slice Selection Function (NSSF) 404, an Access and Mobility Management function (AMF) 406, a Session Management Function (SMF) 408, an Authentication Server Function (AUSF) 410, and a Policy Control Function (PCF) 412. Additional network functions may be implemented within the 5GC-CP 402 to provide any suitable functionality for the network. The UE 110 conducts control-plane signaling over the N1 reference point with the AMF 406. The AMF 406 conducts control-plane signaling with base stations in the RAN 140 using the N2 reference point. Control-plane signaling for session management is communicated between the SMF 408 and the UPF 420 using the N4 reference point. Policy control for session management is communicated over the N7 reference point between the SMF 408 and the PCF 412. The SMF 408 subscribes to information related to the UE 110 from the AMF 406 using the N11 reference point. The AMF 406 uses the N12 interface for authentication of the UE 110 by the AUSF 410. Network slicing assistance information is provided over the N22 reference point between the AMF 406 and the NSSF 404.

The 5GC-CP 402 is configured to communicate with User Data Management (UDM) 414 and an Application Function (AF) 416. In addition, the 5GC-CP 402 communicates with the radio access network (RAN) 140 and a User Plane Function (UPF) 420. The UPF 420 communicates with a Data Network (DN) 422. User-plane data for the UE 110 is communicated over the Uu interface to and from the RAN 140, is communicated over the N3 reference point between the RAN 140 and the UPF 420, and is communicated to and from the DN 422 over the N6 reference point. SMS Subscription data retrieval between the AMF 406 and the UDM 414 occurs over the N8 reference point. Application function requests are sent to the PCF 412 using the N5 reference point.

In aspects, the user equipment 110 may be anchored to the 5G network over an LTE/EPC control plane. In an example, the user equipment 110 accesses the 5G network using the air interface (e.g., the Uu interface) provided by the RAN 140.

Similarities exist between the network functions of the 5G network and the elements of an EPC network, such as the EPC 160 of FIG. 1 or the example 4G/5G NR NSA EN-DC network described in FIG. 3. For example, the AMF 406 includes functionalities that approximately map to functionalities of the MME 306 and the SGW 310. Functionalities of the SMF 408 are approximately equivalent to PGW 312. The approximate functional equivalent of the AUSF 410 is the HSS 308. In addition, functionalities of the UPF 420 are approximately equivalent to functionalities of the SGW 310 and the PGW 312. Although these similarities exist, the functionalities are not identical. In addition, interfaces and protocols of the 5G network are different from the interfaces and protocols used in the EPC network.

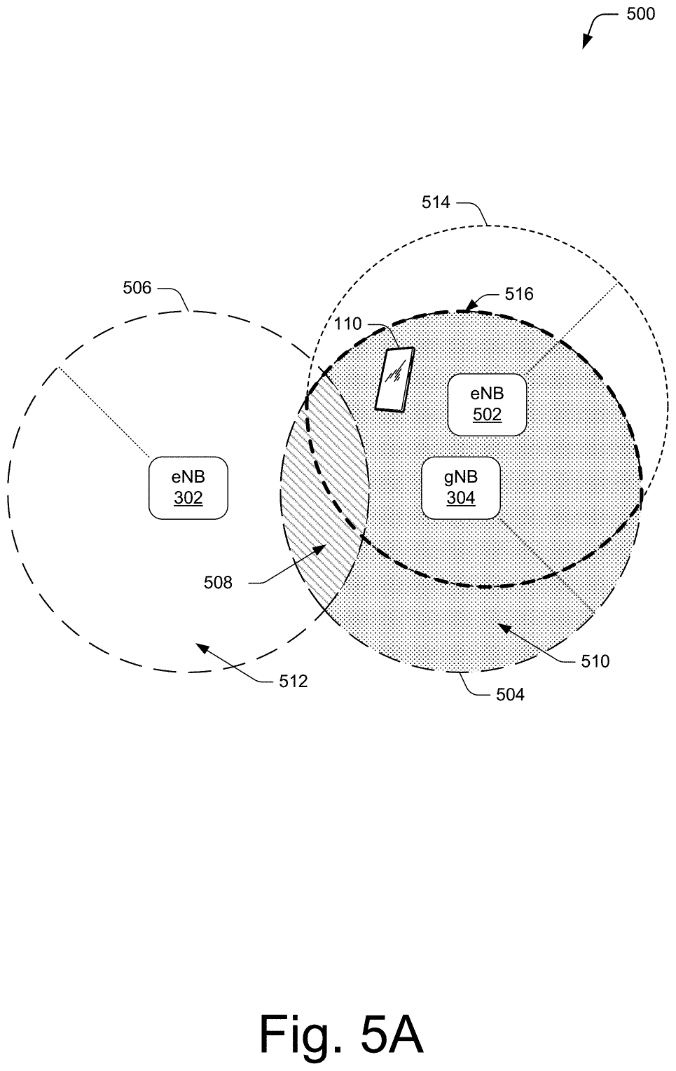

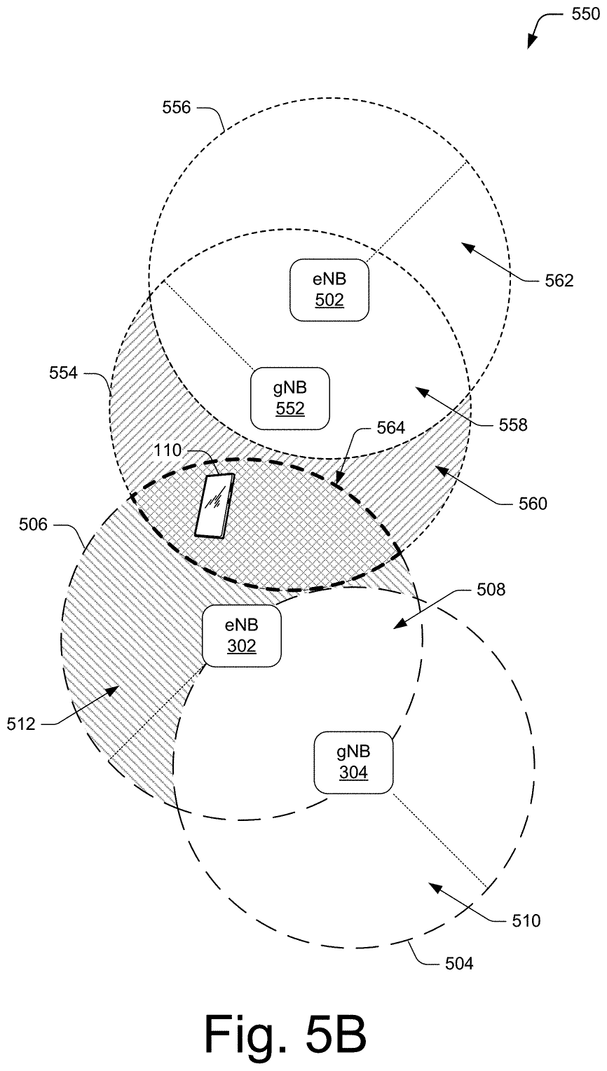

FIG. 5A illustrates an example implementation 500 of a user equipment device in range of various radio access networks. Generally, 5G NR NSA EN-DC requires an LTE anchor link for control and support of the 5G NR link. If the service provider has 5G NR coverage without LTE coverage or vice versa, EN-DC coverage cannot be enabled in that location.

To illustrate this example, the implementation 500 depicts a user equipment 110, a gNB 304 from a first service-provider network, an eNB 302 from the first service-provider network, and an eNB 502 from a second service-provider network. From the first service-provider network, the gNB 304 provides 5G coverage within a 5G-signal range 504 and the eNB 302 provides LTE coverage within an LTE-signal range 506. In this example, however, the 5G-signal range 504 does not substantially overlap the LTE-signal range 506. In the illustrated example, the 5G-signal range 504 and the LTE-signal range 506 include an overlapping area 508 and non-overlapping areas 510 and 512, respectively. The user equipment 110 is located in the non-overlapping area 510 such that the user equipment 110 is within 5G-signal range 504 of the gNB 304 but outside the LTE-signal range 506 of the eNB 302. Because of this, the 5G non-anchor link coverage provided by the gNB 304 cannot be used by the user equipment 110 for EN-DC with an LTE anchor link of the eNB 302. Thus, to obtain anchor link support for EN-DC coverage, the user equipment 110 roams onto a second service provider's LTE network, such as eNB 502 that provides the LTE-signal range 514, which overlaps the 5G non-anchor link coverage at region 516, which includes the location of the user equipment 110.

FIG. 5B illustrates an alternative example implementation 550 of a user equipment device in range of various networks. The example implementation 550 includes the eNB 302 and the gNB 304 from the first service-provider network, the eNB 502 from the second service-provider network, and a gNB 552 from the second service-provider network. From the first service-provider network, the gNB 304 provides 5G coverage within a 5G-signal range 504 and the eNB 302 provides LTE coverage within an LTE-signal range 506. From the second service-provider network, the gNB 552 provides 5G coverage within a 5G-signal range 554 and the eNB 502 provides LTE coverage within an LTE-signal range 556. Similar to the example described with respect to FIG. 5A, the 5G-signal range 504 does not substantially overlap the LTE-signal range 506. Additionally, the 5G-signal range 554 does not fully overlap with the LTE-signal range 556. For instance, from the second service-provider network, the 5G-signal range 554 and the LTE-signal range 556 include an overlapping region 558 and non-overlapping areas 560 and 562, respectively.

The user equipment 110 is located in the non-overlapping area 512 of the first service-provider network such that the user equipment 110 is within the LTE-signal range 506 of the eNB 302 but outside the 5G-signal range 504 of gNB 304. Because of this, the user equipment 110 cannot use the LTE anchor link of the eNB 302 and the 5G non-anchor link coverage provided by the gNB 304 to support EN-DC. However, at region 564, the user equipment 110 is located within the 5G-signal range 554 of the gNB 552 of the second service-provider network. Accordingly, when the user equipment 110 is located in region 564, the user equipment 110 may use an anchor link of the LTE radio access network of the first service-provider network provided by eNB 302 and roam onto a 5G non-anchor link of the 5G NR radio access network provided by the gNB 552 of the second service-provider network to support EN-DC.

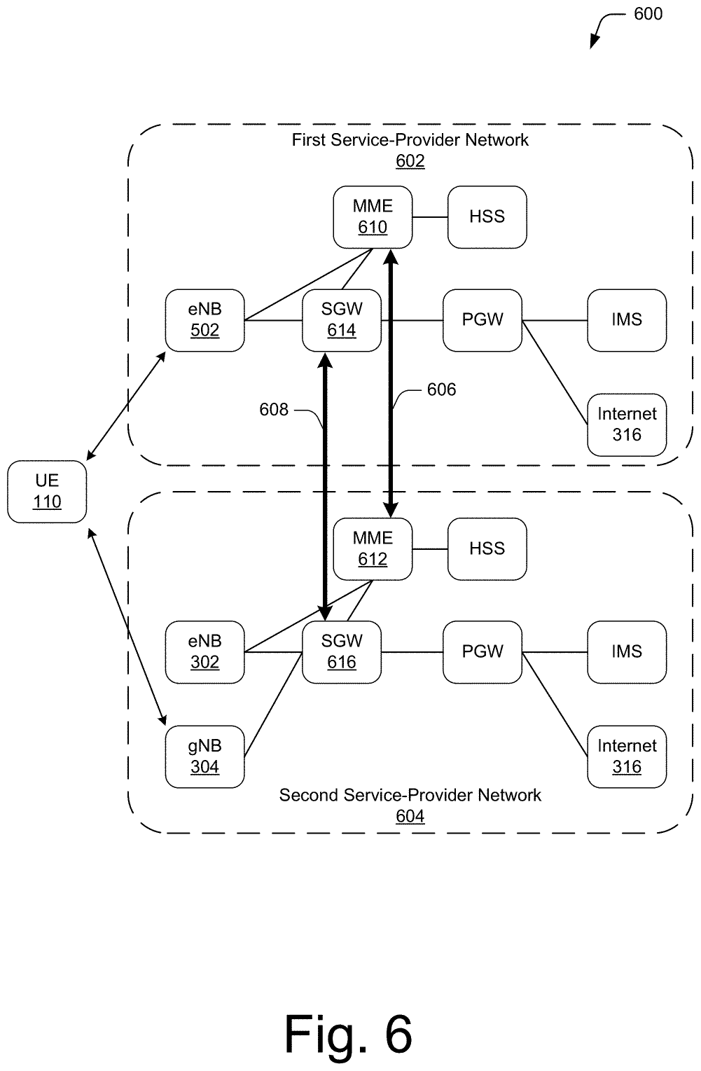

FIG. 6 illustrates an example implementation 600 for enabling 5G NR NSA EN-DC dual-connectivity via DC roaming The example implementation 600 illustrates the user equipment 110, a first service-provider network 602, and a second service-provider network 604. In this example, the first service-provider network 602 provides a 4G LTE network, and the second service-provider network 604 provides a 4G/5G NR NSA network. Assume that the user equipment 110 is located in the non-overlapping area 510 of FIG. 5A where LTE coverage (e.g., LTE coverage provided by eNB 302) of the second service-provider network 604 does not overlap with 5G coverage (e.g., 5G coverage provided by gNB 304) of the second service-provider network 604. Because the 5G radio access network of the second service-provider network 604 is non-stand alone, the user equipment 110, at its current location (e.g., non-overlapping area 510 of FIG. 5A), cannot use a 5G non-anchor link provided by the gNB 304 to communicate using EN-DC without using an anchor link of the LTE coverage. However, referring to the scenario described with respect to FIG. 5A, assume that LTE coverage (e.g., LTE signal range 514 of eNB 502) of the first service-provider network 602 overlaps with the 5G coverage (e.g., 5G signal range 504 of gNB 304) of the second service-provider network. Here, in the region 516, the user equipment 110 can be allowed to use an anchor link of the LTE network of the first service-provider network 602 and access the 5G radio access network of the second service-provider network 604 to support EN-DC. To facilitate DC roaming of the user equipment 110 between different service-provider networks and dual-connectivity of such service-provider networks, at least two roaming interfaces (e.g., DC-roaming interfaces) are provided. In aspects, the roaming interfaces include roaming-control interface 606 and roaming-data interface 608.

The roaming interfaces can be implemented between any suitable component or entity of the core network of each service-provider network. Various alternative examples are illustrated in FIGS. 6-9. In FIG. 6, the roaming-control interface 606 is a user-plane external interface defined between the Mobility Management Entities (MME) of each service-provider network, e.g., between the MME 610 of the first service-provider network 602 and the MME 612 of the second service-provider network 604. An example of the roaming-control interface 606 includes an S11-Roaming interface. In addition, the roaming-data interface 608 is a user-plane external interface defined between the Serving Gateways (SGW) of each service-provider network, e.g., between SGW 614 of service provider-1 602 and SGW 616 of service provider-2 604. An example of the roaming-data interface 608 includes an S1-U-Roaming interface.

The roaming-control interface 606 is used to route control messages between the service-provider networks. In an example, control messages of the 5G radio access network of the second service-provider network 604 can be routed over the LTE radio access network of the first service-provider network 602 via the roaming-control interface 606. Similarly, control messages of the LTE radio access network of the first service-provider network 602 can be routed over the 5G radio access network of the second service-provider network 604 via the roaming-control interface 606.

The control messages may include a variety of different messages, such as basic control information packets, messages that share identity information, user-equipment context information, website identity of a website the user equipment 110 is attempting to access, bearers that the user equipment 110 should have set, configuration information for how to set up those bearers, instructions to perform a handover to a particular base station, and so on. Accordingly, the control messages routed through the roaming-control interface 606 can include any suitable control message.

The roaming-data interface 608 is used to route data between the service-provider networks. The routed data can include data being shared or transmitted between the user equipment 110 and the Internet 316, such as website content or digital media content. In an example, data can be routed to the SGW 616 of the network of second service-provider network 604 from the SGW 614 of the first service-provider network 602. Alternatively, data can be routed to the SGW 614 of the first service-provider network 602 from the SGW 616 of the second service-provider network 604.

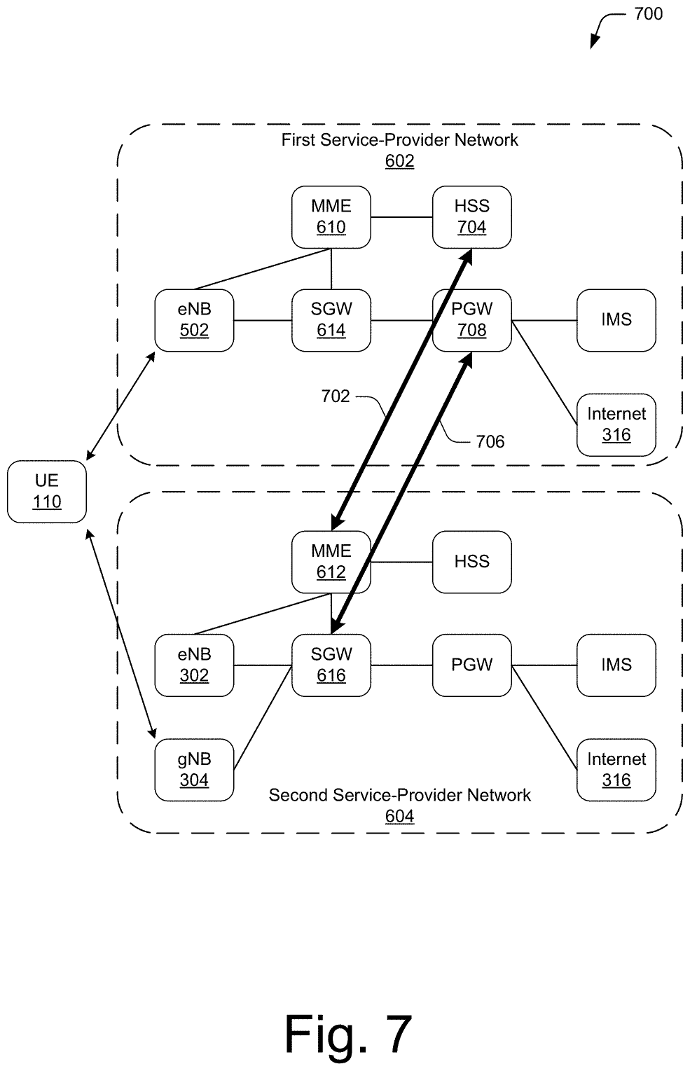

An alternative implementation of the roaming interfaces between different service-provider networks is illustrated in FIG. 7. FIG. 7 illustrates an example implementation 700 for enabling 5G NR NSA EN-DC via DC roaming The example implementation includes roaming interfaces connecting different elements of the LTE and 5G radio access networks. In aspects, a roaming-control interface 702 may be defined between a Home Subscriber Server (HSS) 704 of the first service-provider network 602 and the MME 612 of the second service-provider network 604. An example of the roaming-control interface 702 in the implementation 700 includes an S6a-Roaming interface. In addition, a roaming-data interface 706 may be defined between a packet gateway (PGW) 708 of the first service-provider network 602 and the SGW 616 of the second service-provider network 604. An example of the roaming-data interface 706 in the implementation 700 includes an S5-Roaming interface.

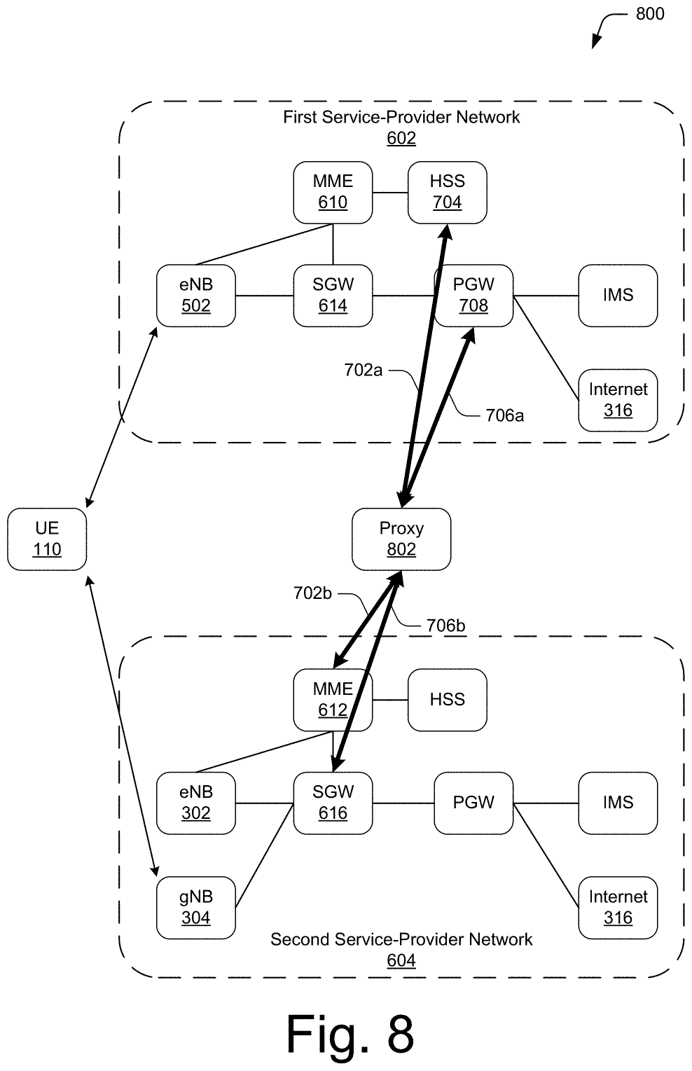

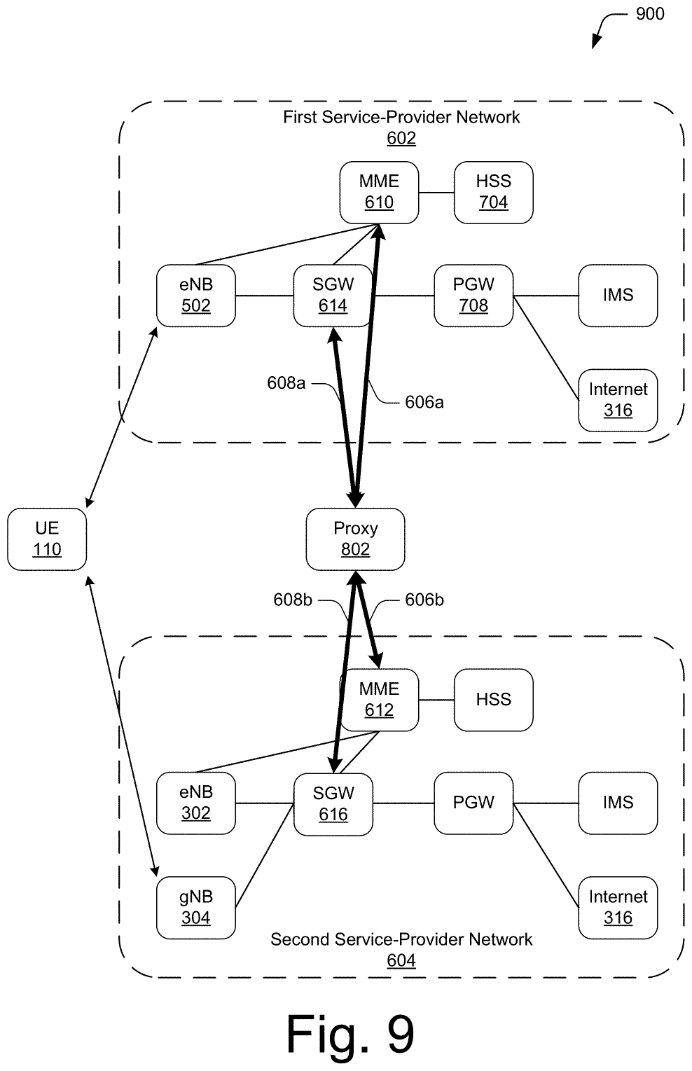

FIGS. 8 and 9 illustrate alternative implementations 800 and 900, respectively, for enabling 5G NR NSA EN-DC via DC roaming For example, FIGS. 8 and 9 illustrate a proxy server 802 between the first service-provider network 602 and the second service-provider network 604. By using a proxy server, service providers can provide an additional level of security and avoid direct connections with other service-provider networks. For example, the proxy server 802 can handle security, have a known identity, authenticate with other service-provider networks, and so on. In this way, the first service-provider network 602 and the second service-provider network 604 are not required to communicate with one another directly. Rather, each service-provider network can communicate with the other service-provider network via the proxy server 802, which may be well-firewalled and isolated for security purposes.

In the example implementation 800 illustrated in FIG. 8, the proxy server 802 is employed between the HSS 704 of the first service-provider network 602 and the MME 612 of the second service-provider network 604 to facilitate communication of, and manage security and firewalls for, control messages between the service-provider networks. The control messages can be communicated between the service-provider networks via a roaming interface, such as roaming-control interfaces 702a and 702b, which may be instances of roaming-control interface 702 from FIG. 7. In addition, the proxy server 802 can be employed between the PGW 708 of the first service-provider network 602 and the SGW 616 of the second service-provider network 604 to facilitate communication of, and manage security and firewalls for, data between the service-provider networks. The data can be communicated between the service-provider networks via a roaming interface, such as roaming-data interfaces 706a and 706b, which are instances of roaming-data interface 706 from FIG. 7.

In the example implementation 900 illustrated in FIG. 9, the proxy server 802 is employed between the MME 610 of the first service-provider network 602 and the MME 612 of the second service-provider network 604 to facilitate transmission of, and manage security and firewalls for, control messages between the service-provider networks. The control messages can be communicated between the service providers via a roaming interface, such as roaming-control interfaces 606a and 606b, which are instances of roaming-control interface 606 from FIG. 6. In addition, the proxy server 802 is employed between the SGW 614 of the first service-provider network 602 and the SGW 616 of the second service-provider network 604 to facilitate communication of, and manage security and firewalls for, data between the service-provider networks. The data can be communicated between the service-provider networks via a roaming interface, such as roaming-data interfaces 608a and 608b, which are instances of roaming-data interface 608 from FIG. 6.

### Example Procedures

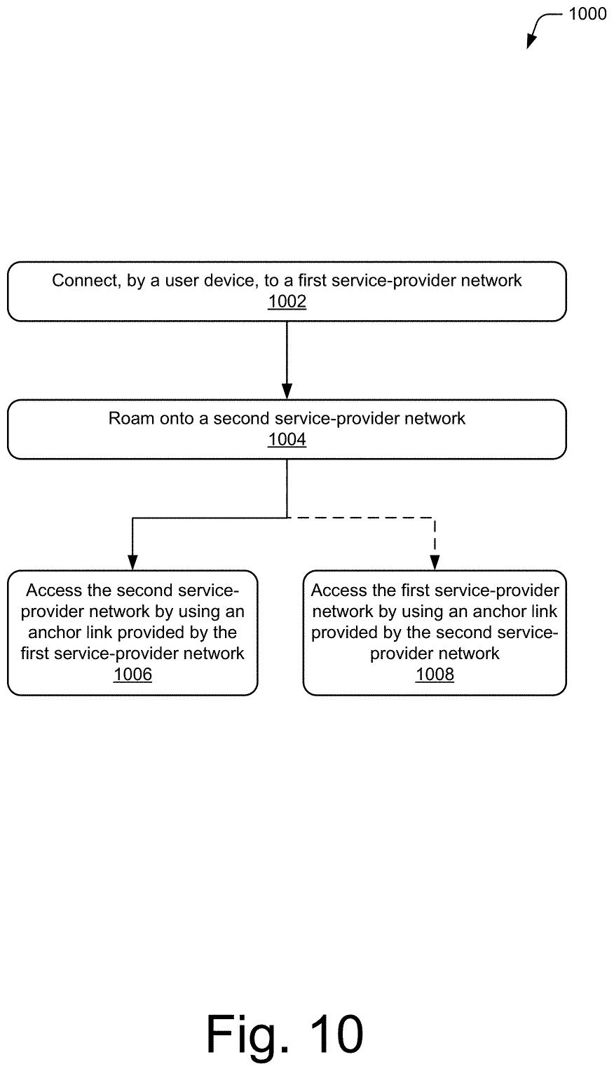

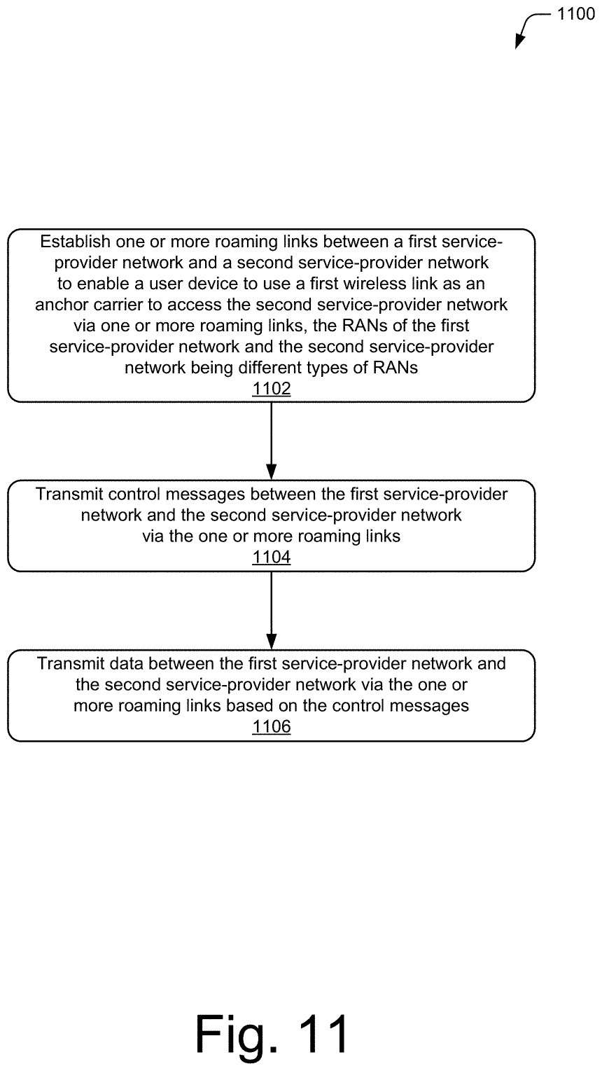

Example methods 1000 and 1100 are described with reference to FIGS. 10 and 11, respectively, in accordance with one or more aspects of enabling 5G NR NSA EN-DC via DC roaming. Generally, any of the components, modules, methods, and operations described herein can be implemented using software, firmware, hardware (e.g., fixed logic circuitry), manual processing, or any combination thereof Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 10 depicts an example method 1000 of for supporting 5G NR NSA EN-DC via DC roaming in a user device in accordance with aspects of the techniques described herein. The order in which the method blocks are described are not intended to be construed as a limitation, and any number of the described method blocks can be skipped or combined in any order to implement a method, or an alternate method.

At block 1002, a user device connects to a first service-provider network. In one example, the user equipment 110 of FIG. 1 may connect to an LTE network of the first service-provider network 602 of FIGS. 6-9. Alternatively, the user equipment 110 may connect to a 5G NR network of the second service-provider network 604.

At block 1004, the user device DC roams onto a second service-provider network (e.g., a service-provider network different from the first service-provider network) to support EN-DC. If the user equipment 110 first connected to the LTE network of the first service-provider network 602, then the user equipment 110 may DC roam onto the 5G NR network of the second service-provider network 604 via one or more roaming interfaces defined between the two service-provider networks, such as the roaming-control interface 606 and the roaming-data interface 608 described with respect to FIGS. 6 and 7, or via the proxy server 802 of FIGS. 8 and 9.

Alternatively, if the user equipment 110 first connected to the 5G network of the second service-provider network 604, then the user device may use an LTE anchor link of the first service-provider network 602 to support EN-DC via the one or more interfaces between the networks. An anchor link of the first service-provider network (e.g., the LTE network of the first service-provider network 602) is used along with a non-anchor link of the second service-provider network (e.g., the 5G network of the second service-provider network 604).

At block 1006, the user device accesses the second service-provider network by using an anchor link of the first service-provider network to support EN-DC. An example is described with respect to FIG. 5B. For instance, if the first service-provider network is an LTE network and the second service-provider network is a 5G network, the user equipment 110 is allowed to use the anchor link of the LTE network of the first service-provider network and the 5G non-anchor link of the second service-provider network to communicate using EN-DC, based on a DC-roaming connection to the gNB 304 of the second service-provider network 604 and the support of the LTE anchor link provided by the first service-provider network 602.

Alternatively, if the first service-provider network is a 5G network and the second service-provider network is an LTE network, then at block 1008, the user device uses the 5G network of the first service-provider network by using an anchor link of the second service-provider network to communicate using EN-DC. An example is described with respect to FIG. 5A. For example, the user equipment 110 is allowed to access the Internet via the 5G NR network, based on a DC-roaming connection to the LTE network of the first service-provider network 602 that provides an LTE anchor link.

FIG. 11 depicts an example method 1100 for enabling 5G NR NSA EN-DC via DC roaming in a network in accordance with aspects of the techniques described herein. The order in which the method blocks are described are not intended to be construed as a limitation, and any number of the described method blocks can be skipped or combined in any order to implement a method, or an alternate method.

At block 1102, one or more DC-roaming links are established between a first service-provider network and a second service-provider network to enable a user device to use a wireless communication link provided by the first service-provider network as an anchor link to access the second service-provider network via the one or more DC-roaming links. In aspects, the RANs of the first service-provider network and the second service-provider network are different types of RANs. In one example, the proxy server 802 may receive a roaming request from the user equipment 110 via an element of the LTE network of the first service-provider network 602. Based on this request, the proxy server 802 communicates with the 5G NR network of the second service-provider network 604 to establish DC-roaming links between the LTE network and the 5G NR network. In an example, the proxy server 802 may authenticate the user equipment 110 with the second service-provider network 604 and handle any suitable security and firewall checks of the second service-provider network 604 in order to establish the DC-roaming links.

In another example, the proxy server 802 may receive a DC-roaming request from the user equipment 110 via an element of the 5G radio access network of the second service-provider network 604. The proxy server 802 may transmit the DC-roaming request to the other service-provider network, such as the LTE network of the first service-provider network 602. The proxy server 802 may authenticate the user equipment 110 with the first service-provider network 602 and handle any suitable security and firewall checks of the first service-provider network 602 to establish the DC-roaming links.

At block 1104, control messages are transmitted between the first service-provider network and the second service-provider network via the one or more DC-roaming links. For example, the proxy server 802 may receive control messages from the LTE network of first service-provider network 602 (e.g., from the MME 610 or the HSS 704) and transmit those control messages to the 5G radio access network of the second service-provider network 604 (e.g., to the MME 612 or functional equivalent such as the AMF 406 or the SMF 408). Alternatively or in addition, the proxy server 802 may receive control messages from the 5G radio access network of the second service-provider network 604 and transmit those control messages to the LTE network of the first service-provider network 602.

At block 1106, data is transmitted between the first service-provider network and the second service-provider network via the one or more DC-roaming links based on the control messages. For example, the proxy server 802 may receive and transmit data corresponding to the control messages from one service-provider network to the other service-provider network via the roaming interfaces. In one example, the proxy server 802 receives data from the LTE network of the first service-provider network 602 (e.g., from PGW 708 or the SGW 614) and transmits the data to the 5G network of the second service-provider network 604 (e.g., to the SGW 616 or functional equivalent such as the SMF 408). Alternatively or in addition, the proxy server 802 may receive data from the 5G radio access network of the second service-provider network 604 and transmit the data to the LTE network of first service-provider network 602.

In the following, several examples are described.

Example 1: A method for supporting fifth generation new radio non-standalone evolved universal terrestrial radio access network new radio dual-connectivity via dual-connectivity roaming, the method comprising: connecting, by a user device, to a first service-provider network; dual-connectivity roaming, by the user device, onto a second service-provider network, the dual-connectivity roaming is enabled based on dual-connectivity roaming links including a roaming-control interface usable to route control messages between the first service-provider network and the second service-provider network, the dual-connectivity roaming links including a roaming-data interface usable to route data between the first service-provider network and the second service-provider network based on the control messages; and accessing, by the user device, the second service-provider network while using an anchor link from the first service-provider network or an anchor link from the second service-provider network.

Example 2: A method as recited in example 1, wherein the second service-provider network is accessed using the anchor link from the first service-provider network and a non-anchor link from the second service-provider network.

Example 3: A method as recited in example 1, wherein the second service-provider network is accessed using the anchor link from the second service-provider network and a non-anchor link from the first service-provider network.

Example 4: A method as recited in example 1, wherein the user device is located: within a first signal range of a first radio access network of the first service-provider network, the first radio access network comprising an LTE or LTE-Advanced radio access network; within a second signal range of a second radio access network of the second service-provider network, the second radio access network comprising a first 5G NR radio access network; and outside a third signal range of a third radio access network of the first service-provider network, the third radio access network comprising a second 5G NR radio access network.

Example 5: A system for supporting fifth generation new radio non-standalone evolved universal terrestrial radio access network new radio dual-connectivity via dual-connectivity roaming, the system comprising: a first service-provider network including: a base station configured to provide a cell of a first radio access network to a user device for accessing the first service-provider network; and a plurality of roaming interfaces configured to enable the user device to dual-connectivity roam onto a second service-provider network by using an anchor link of the first radio access network while accessing a second radio access network of the second service-provider network, the plurality of roaming interfaces including: a roaming-control interface usable to route control messages between the first service-provider network and the second service-provider network; and a roaming-data interface usable to route data between the first service-provider network and the second service-provider network based on the control messages.

Example 6: The system of example 5, wherein the roaming-control interface is established between a first mobility management entity of the first service-provider network and a second mobility management entity of the second service-provider network.

Example 7: The system of example 5, wherein the roaming-data interface is established between a first serving gateway of the first service-provider network and a second serving gateway of the second service-provider network.

Example 8: The system of example 5, wherein the roaming-control interface is established between a home subscriber server of the first service-provider network and a mobility management entity of the second service-provider network.

Example 9: The system of example 5, wherein the roaming-data interface is established between a packet gateway of the first service-provider network and a serving gateway of the second service-provider network.

Example 10: The system of example 5, wherein the roaming-control interface is established between a first mobility management entity of the first service-provider network and a proxy server configured to interface with a second mobility management entity of the second service-provider network.

Example 11: The system of example 5, wherein the roaming-data interface is established between a first serving gateway of the first service-provider network and a proxy server configured to interface with a second serving gateway of the second service-provider network.

Example 12: The system of example 5, wherein the roaming-control interface is established between a home subscriber server of the first service-provider network and a proxy server configured to interface with a second mobility management entity of the second service-provider network.

Example 13: The system of example 5, wherein the roaming-data interface is established between a packet gateway of the first service-provider network and a proxy server configured to interface with a second serving gateway of the second service-provider network.

Example 14: A method for supporting fifth generation new radio non-standalone evolved universal terrestrial radio access network new radio dual-connectivity via dual-connectivity roaming, the method comprising: establishing, by a proxy server, one or more dual-connectivity roaming links between a first service-provider network and a second service-provider network to enable a user device to use an anchor link of a first radio access network of the first service-provider network and access a second radio access network of the second service-provider network via the one or more dual-connectivity roaming links, the first radio access network and the second radio access network being different radio access network types; transmitting, by the proxy server, control messages between the first service-provider network and the second service-provider network via the one or more dual-connectivity roaming links; and transmitting, by the proxy server, data between the first service-provider network and the second service-provider network via the one or more dual-connectivity roaming links based on the control messages.

Example 15: A method as recited in example 14, further comprising: enabling, by the proxy server, the user device to dual-connectivity roam onto the first radio access network from the second radio access network, the second radio access network comprising a fifth generation new radio access network.

Example 16: A method as recited in example 14, further comprising: enabling, by the proxy server, the user device to dual-connectivity roam onto the second radio access network from the first radio access network, the second radio access network comprising a fifth generation new radio network.

Example 17: A method as recited in example 14, further comprising establishing, by the proxy server, the one or more dual-connectivity roaming links: between a first mobility management entity of the first service-provider network and a second mobility management entity of the second service-provider network; and between a first serving gateway of the first service-provider network and a second serving gateway of the second service-provider network.

Example 18: A method as recited in example 14, further comprising establishing, by the proxy server, the one or more dual-connectivity roaming links: between a home subscriber server of the first service-provider network and a mobility management entity of the second service-provider network; and between a packet gateway of the first service-provider network and a serving gateway of the second service-provider network.

Example 19: A method as recited in example 14, further comprising establishing, by the proxy server, the one or more dual-connectivity roaming links: between a network slice selection function of the second service-provider network and a first mobility management entity of the first service-provider network; and between a mobility management entity of the second service-provider network and a serving gateway of the first service-provider network.

Example 20: A method as recited in example 14, further comprising establishing, by the proxy server, the one or more dual-connectivity roaming links: between a network slice selection function of the second service-provider network and a home subscriber server of the first service-provider network; and between a mobility management of the second service-provider network and a packet gateway of the first service-provider network.

Although aspects of enabling 5G NR NSA EN-DC via DC roaming have been described in language specific to features and/or methods, the subject of the appended claims is not necessarily limited to the specific features or methods described. Rather, the specific features and methods are disclosed as example implementations of enabling 5G NR NSA EN-DC via DC roaming, and other equivalent features and methods are intended to be within the scope of the appended claims. Further, various different aspects are described and it is to be appreciated that each described aspect can be implemented independently or in connection with one or more other described aspects.

1. A method for supporting fifth generation new radio non-standalone evolved universal terrestrial radio access network new radio dual-connectivity via dual-connectivity roaming, the method comprising:
connecting, by a user device, to a first service-provider network;
dual-connectivity roaming, by the user device, onto a second service-provider network, the dual-connectivity roaming is enabled based on dual-connectivity roaming links including a roaming-control interface usable to route control messages between the first service-provider network and the second service-provider network, the dual-connectivity roaming links including a roaming-data interface usable to route data between the first service-provider network and the second service-provider network based on the control messages; and
accessing, by the user device, the second service-provider network while using an anchor link from the first service-provider network or an anchor link from the second service-provider network.

2. (canceled)

3. (canceled)

4. (canceled)

5. A system for supporting fifth generation new radio non-standalone evolved universal terrestrial radio access network new radio dual-connectivity via dual-connectivity roaming, the system comprising:
a first service-provider network including:
a base station configured to provide a cell of a first radio access network to a user device for accessing the first service-provider network; and
a plurality of roaming interfaces configured to enable the user device to dual-connectivity roam onto a second service-provider network by using an anchor link of the first radio access network while accessing a second radio access network of the second service-provider network, the plurality of roaming interfaces including:
a roaming-control interface usable to route control messages between the first service-provider network and the second service-provider network; and
a roaming-data interface usable to route data between the first service-provider network and the second service-provider network based on the control messages.

6. The system of claim 5, wherein the roaming-control interface is established between a first mobility management entity of the first service-provider network and a second mobility management entity of the second service-provider network.

7. The system of claim 5, wherein the roaming-data interface is established between a first serving gateway of the first service-provider network and a second serving gateway of the second service-provider network.

8. The system of claim 5, wherein the roaming-control interface is established between a home subscriber server of the first service-provider network and a mobility management entity of the second service-provider network.

9. The system of claim 5, wherein the roaming-data interface is established between a packet gateway of the first service-provider network and a serving gateway of the second service-provider network.

10. The system of claim 5, wherein the roaming-control interface is established between a first mobility management entity of the first service-provider network and a proxy server configured to interface with a second mobility management entity of the second service-provider network.

11. The system of claim 5, wherein the roaming-data interface is established between a first serving gateway of the first service-provider network and a proxy server configured to interface with a second serving gateway of the second service-provider network.

12. The system of claim 5, wherein the roaming-control interface is established between a home subscriber server of the first service-provider network and a proxy server configured to interface with a second mobility management entity of the second service-provider network.

13. The system of claim 5, wherein the roaming-data interface is established between a packet gateway of the first service-provider network and a proxy server configured to interface with a second serving gateway of the second service-provider network.

14. A method for supporting fifth generation new radio non-standalone evolved universal terrestrial radio access network new radio dual-connectivity via dual-connectivity roaming, the method comprising:
establishing, by a proxy server, one or more dual-connectivity roaming links between a first service-provider network and a second service-provider network to enable a user device to use an anchor link of a first radio access network of the first service-provider network and access a second radio access network of the second service-provider network via the one or more dual-connectivity roaming links, the first radio access network and the second radio access network being different radio access network types;
transmitting, by the proxy server, control messages between the first service-provider network and the second service-provider network via the one or more dual-connectivity roaming links; and
transmitting, by the proxy server, data between the first service-provider network and the second service-provider network via the one or more dual-connectivity roaming links based on the control messages.

15. (canceled)

16. (canceled)

17. A method as recited in claim 14, further comprising establishing, by the proxy server, the one or more dual-connectivity roaming links:
between a first mobility management entity of the first service-provider network and a second mobility management entity of the second service-provider network; and
between a first serving gateway of the first service-provider network and a second serving gateway of the second service-provider network.

18. A method as recited in claim 14, further comprising establishing, by the proxy server, the one or more dual-connectivity roaming links:
between a home subscriber server of the first service-provider network and a mobility management entity of the second service-provider network; and
between a packet gateway of the first service-provider network and a serving gateway of the second service-provider network.

19. A method as recited in claim 14, further comprising establishing, by the proxy server, the one or more dual-connectivity roaming links:
between a network slice selection function of the second service-provider network and a first mobility management entity of the first service-provider network; and
between a mobility management entity of the second service-provider network and a serving gateway of the first service-provider network.

20. A method as recited in claim 14, further comprising establishing, by the proxy server, the one or more dual-connectivity roaming links:
between a network slice selection function of the second service-provider network and a home subscriber server of the first service-provider network; and
between a mobility management of the second service-provider network and a packet gateway of the first service-provider network.

21. The method of claim 1, wherein the roaming-control interface is established between a first mobility management entity of the first service-provider network and a second mobility management entity of the second service-provider network.

22. The method of claim 1, wherein the roaming-data interface is established between a first serving gateway of the first service-provider network and a second serving gateway of the second service-provider network.

23. The method of claim 1, wherein the roaming-control interface is established between a home subscriber server of the first service-provider network and a mobility management entity of the second service-provider network.

24. The method of claim 14, wherein the establishing one or more dual-connectivity roaming links between a first service-provider network and a second service-provider network further comprises:
establishing, by the proxy server, the one or more dual-connectivity roaming links between a first mobility management entity of the first service-provider network and a home subscriber server of the second service-provider network.

25. The method of claim 14, wherein the establishing one or more dual-connectivity roaming links between a first service-provider network and a second service-provider network further comprises:
establishing, by the proxy server, the one or more dual-connectivity roaming links between a first serving gateway of the first service-provider network and a packet gateway of the second service-provider network.
